(19) United States
(12) Patent Application Publication
(10) Pub. No.: US 2004/0181493 A1
(43) Pub. Date: Sep. 16, 2004

(54) Method and system for real-time transactional information processing

(76) Inventors: Thomas M. Cross, Clarkston, MI (US); Thomas G. Gagne, Ferndale, MI (US); Charlie G. Gagne, Dexter, MI (US)

Correspondence Address: DYKEMA GOSSETT PLLC, Suite 300, 39577 Woodward Avenue, Bloomfield Hills, MI, 48304, US

(21) Appl. No.: 10/808,029

(22) Filed: Mar. 24, 2004

Related U.S. Application Data
(63) Continuation of application No. 09/695,930, filed on Oct. 26, 2000.

(51) Int. Cl. G06F 17/60

(52) U.S. Cl. 705/75

(57) ABSTRACT

A system is provided for facilitating commerce between a buyer and a seller. The system includes a central processing platform having: a translator adapted to translate seller information relating to a product or service sale from a seller information format into a buyer information format; a validator adapted to validate a transaction by matching billing information associated with the product sale, and supplied electronically by the seller to the central processing platform, with receipt and acceptance information associated with the product, supplied electronically by the buyer to the central processing platform; and a reconciliator adapted to discriminate and reconcile discrepancies between the billing information and the receipt and acceptance information and to report the discrepancies to the seller.

### BACKGROUND OF THE INVENTION

1. Field of the Invention

The present invention relates to the field of financial information processing, and more particularly a centralized financial information processing platform that facilitates real-time business to business (B2B) e-commerce.

2. Description of the Related Art

Financial transactions between businesses, sometimes referred to as “B2B” commerce, involve, among other things, transfers of goods, funds, and information. Up to now, the processing required by the various parties to the transaction to account for those transfers has imposed a burden that limits productivity.

FIG. 1 illustrates the transfers and process steps involved in a typical commercial transaction between a buyer and seller. Generally, a transaction for goods is initiated by a buyer 10 sending a purchase order to the seller 20. In response to receipt of the purchase order from the buyer 10, seller's shipping department 30 packs the ordered items 22 to be delivered and prepares a packing slip 25 to be included with the items 22. The ordered items 22 are shipped to the buyer 10 together with the packing slip 25. Shipment information may be gathered manually or automatically from the packing slip by scanning of line item bar codes. The seller's shipping department 30 then sends shipment information to the billing department 32, which prepares an invoice 27 and sends the invoice 27 to the buyer 10.

At the buyer 10, the received items 22 and packing slip 25 are handled by the buyer's receiving department 40, which receives the items 22, enters into the buyer's computer the fact that they have been received, and matches up the received items with the line items on the purchase order. Often, this process is automated by scanning in a bar code on the packing slip for each shipped item. Note that for this system to work properly, sellers must bar code the line items to contain any information required by the buyer. Buyer's receiving department 40 forwards information as to what actually has been received, to the buyer's payables processing department 42. In addition to receiving the receipt information from the receiving department 40, the payables processing department 42 also receives the invoice information from the seller 20.

At the seller 20, once the invoice has been sent to the buyer 10, the seller's billing department 32 sends invoice information internally to the seller's collections department 34, which performs reporting and collection activity. At the buyer 10, payables processing 42 reconciles the received invoice to the purchase order and receipt information.

Buyer's payables processing department 42 communicates with the seller 20 to provide payment information and to pay the invoice. Payment is made typically by forwarding a check 28 to the seller 20 in the amount of the invoice, minus any credits that may be taken for missing items, defective items, incorrect items, or the like. Once the check 28 has been received by seller's collections department 34, payment information is forwarded to the seller's accounting department 36.

Seller's collections department 34 reconciles any credits by communicating with the buyer's payables processing department 42. Seller's accounting department 36 records the payment and forwards credit information to seller's quality control department 38.

It is the responsibility of the seller's quality control department 38 to prove that credits were not warranted. Typically, this requires communication with the buyer's quality control department 44 which updates the receipt information sent to the buyer's payables processing department 42. Once the correct amount of credits has been determined, another check may be cut, or more goods shipped, or both, until the order is complete and completely paid for.

While the above exemplary process may work relatively smoothly where there are no discrepancies in the order that would lead to credits being taken, the very nature of the traditional shipping and invoicing process ensures that certain of the steps involved will be labor intensive and cumbersome. For example, keeping track of receivables on the part of the seller can require a tremendous amount of manual effort. Buyers also must keep track of what has been received in comparison with what has been ordered, as well as what is listed on related invoices.

Other difficulties also are, to some extent, inherent in the nature of the process. For example, the line items that appear on the packing slip list only those items shipped in the particular shipment. However, this list may not list all of the items called for in the buyer's purchase order, if some of those items have been shipped separately. An individual in the buyer's receiving department 40 must correlate items as they come in against first the packing slip, and then the purchase order. Adding to the difficulty of keeping track of the shipped items is the fact that invoice line items correspond to items delivered over a particular period of time, not to items contained in a particular shipment.

Moreover, the buyer's payables processing department typically pays invoices based on date of receipt of the items. Thus, a payables clerk must manually go through invoices and, for each line item, match up what actually has been received with what is listed on the invoice. This process is very labor intensive, and, when carried out for a large number of transactions, can add considerable expense to the cost of doing business.

The time that it takes to reconcile payments with shipped items can be greatly extended if there are problems, or perceived problems, with the order. In such a case, a check from the buyer might have a credit subtracted to account for a defective or undelivered item. However, the seller may not be able to determine from the face of the check to which invoice line item the credit corresponds. When this situation occurs, a person at the seller's place of business must telephone a person at the buyer's place of business and go over the invoice item by item until the discrepancy is resolved.

Further, while it is the seller's payables department's personnel that usually has the task of speaking to the buyer concerning disputed credits, it is generally the seller's plant that actually has the capability of resolving quality related problems.

Thus, there is a need for a way to streamline the selling and purchasing process to minimize the amount of manual effort required in the collection of receivables, and to centralize the invoice, purchase order, shipping, billing and payment information.

It also is a fact of business that sellers need a constant source of funds, in large part because of the need to buy new product to sell, or, in the case of manufacturers, raw materials and plant equipment to assist in making the product. Merchants that supply the sellers wish to be paid right away, and will not wait for the seller to sell its products, still less for the buyers to pay the seller for the products. To encourage early payments, sellers typically offer discounts for early payment, such as 2% off the invoice price for payment within 10 days. Often this incentive is not enough, however, and the seller must resort to financing based upon expected payment on its receivables, or the outright sale of such receivables. Among the choices available for sellers in this position are the use of factors, i.e., entities that purchase accounts receivable outright, or receivables financing providers, i.e., financial institutions that provide lines of credit, or individual loans, against a total of eligible receivables.

There is no guarantee that a buyer will pay an invoice timely, or at all. Thus, to safely provide cash in exchange for an invoice, or financing based on expected receipt of payment, factors and financial entities offering lines of credit check the credit worthiness of the buyer, as well as the buyer's acceptance of the merchandise. For example, a factor may consult with Dun and Bradstreet information as to the buyer and analyze the results. Such “back-end processing” is labor intensive because it involves making requests for information from the buyer and the seller, as well as to and from other parties, such as insurance providers and credit reporting agencies. The back-end processing required to keep track of this information is seen by factors as a necessary evil. Moreover, even when armed with this information, factors and lending institutions are still faced with credit and fraud risks. And while firms exist that offer fraud or credit insurance, smaller factoring operations cannot afford to purchase such insurance.

Adding to the complexity of the factoring process is the fact that factors keep track of the progress of a transaction differently from other parties of the transaction. For example, factors currently validate manually at the invoice level, not at the line item level. This means that a great deal effort expended by the seller is duplicated by the factor, and that providing the information to a factor may require a reformatting of the transaction data to meet the factor's specifications.

Thus, there is a need for an information source that would allow factors and receivables financing entities to have access to properly formatted transaction information of buyers and sellers to enable the factors to make better informed decisions. There also is a need for a way to provide smaller factors access to such risk-reducing services as fraud and credit insurance, that up to now has been affordable only by large factors.

In addition to the above difficulties in the present system of B2B commerce, the recent development of B2B trading exchanges, also referred to as marketplaces, has changed the way large buyers and sellers do business. Such exchanges act as collaborative trading communities to allow exchange participants to enjoy economies of scale in procurement and sales. Examples of “competitor exchanges” are the Global Net Exchange, which has as its members Sears, Carrefour, Sainsbury, and others, the Worldwide Retail Exchange, which includes Kmart, Target, Walgreens, Tesco and others, and the Grocery Manufacturers' Association eCPG, which include P&G, Unilever, Kraft Foods, and many other food manufacturers. Trading exchanges may be private rather than collaborative, in which case they are run, for example, by a single large manufacturer, such as General Motors, and all prospective suppliers must bid on the exchange in order to sell to the manufacturer.

Generally, a B2B exchange operates by means of a computer-based platform that includes applications for identifying qualified vendors, products and terms of sale, and to allow electronic communication between the various participants. If multiple buyers are involved, the applications operate to aggregate the needs of many buyers into a buying pool, resulting in larger purchasing transactions. The exchange also may include software applications allowing auctions, or reverse auctions to be run.

Some very large buyers controlling their own exchanges utilize a particular Electronic Data Interchange (EDI) format that all sellers wishing to participate in the exchange must utilize. While larger suppliers have found it cost effective to meet the interface specifications of these buyers, many smaller suppliers are shut out of the exchange because they cannot afford to put in place the electronic infrastructure required to communicate over the buyer's EDI format. Thus, all potential suppliers are not able to participate, limiting the benefit gained by participants.

Moreover, currently, exchanges are limited in their payment capabilities. The most common way for payment to be made in exchanges today is to have participants handle payment outside of the exchange environment using their traditional practices. Recently, exchanges have begun to introduce payment by a credit card (P-card). However, this method has considerable drawbacks. In particular, P-cards do not integrate well with buyer enterprise resource planning (ERP) systems and require the buyer to change its approval process. An ERP system is a company wide, transaction processing and planning system that manages a company's payroll, financials, inventory, procurement, planning and other corporate functions. P-cards take part of the procurement process out of the control of the ERP system.

Thus, there also exists a need for providing an interface between smaller players in the market and large exchanges, as well as a need to provide an efficient method of payment on the exchanges. Further, currently, invoices cannot be traded as commodities. Invoices are generally part of the seller's collateral base and cannot be sold independently. Additionally, current UCC lien Laws do not provide creditors with protection necessary to handle invoice by invoice trading.

Further, invoices purchased by factors are not tradeable instruments. This is because purchased invoices are subject to UCC lien laws that attach preference to creditors based on filing order rather than purchase history.

Thus, there exists a need for a method of converting invoices into tradable instruments.

### SUMMARY OF THE INVENTION

In view of the above deficiencies of the prior art, it is an object of the present invention to provide an information network for centralizing and coordinating the exchange of information between and among the various parties to a commercial transaction. The network preferably incorporates at least three functionalities: a) a translation engine to provide translation between data formats used by the various parties to a transaction; b) a validation engine, to validate, at the line item level, shipping data with a buyer to ensure payment by the buyer; and c) a reconciliation engine, to reconcile shipping line items electronically.

It is another object of the present invention to create a financial network to provide, in a single platform: a) receivables processing for individual companies engaged in business to business commerce; and b) back-end processing of financed receivables by factors and other financial entities.

According to one aspect of the present invention, there is provided a system for facilitating commerce between a buyer and a seller. The system includes a central processing platform comprising: a translation engine adapted to translate seller information relating to a product or service sale from a seller information format into a buyer information format and to forward the translated information to the buyer; a validation engine adapted to validate a transaction by matching billing information associated with the product sale, and supplied electronically by the seller to the central processing platform, with receipt and acceptance information associated with the product, supplied electronically by the buyer to the central processing platform; and a reconciliation engine adapted to discriminate and reconcile discrepancies between the billing information and the receipt and acceptance information.

According to another aspect of the present invention, there is provided a server on a network. The server facilitates commerce between a buyer and a seller and is operable to: receive information from the seller in a seller information format, the information relating to a commercial transaction between the seller and the buyer; translate the received information into a buyer information format and forward the translated information to the buyer; validate a transaction by matching billing information associated with the commercial transaction, and supplied electronically by the seller to the server, with receipt and acceptance information associated with the commercial transaction, supplied electronically by the buyer to the server; and discriminate and reconcile discrepancies between the billing information and the receipt and acceptance information.

According to another aspect of the present invention, there is provided computer code for transaction validation and reconciliation. The computer code comprises: code for receiving billing information from a seller involved in a commercial transaction; code for obtaining receipt and acceptance information from a buyer in the commercial transaction; and code for discriminating discrepancies between the billing information and the receipt and acceptance information.

According to yet another aspect of the present invention, there is provided a method for a central processing platform to convert a receivable, to be paid by a buyer to a seller, into a tradeable financial instrument. The method comprises: obtaining credit information relating to the buyer; procuring-insurance against non-payment of the receivable by the buyer; assessing risk of non-payment by the buyer based upon the obtained credit information, and information relating to the seller, in accordance with predetermined rules; procuring fraud insurance as to the receivable; procuring insurance against non-acceptance by the buyer of a product associated with the receivable; and becoming a payment agent for the receivable.

According to still another aspect of the present invention, there is provided a central processing platform controlling an associated processing financial institution. The central processing platform facilitates an exchange of information and funds between a seller participant in an e-commerce marketplace and a buyer participant in the e-commerce marketplace. The central processing platform is operable to: receive billing information and other transaction information from the seller; convert the billing information to an extensible markup language (XML) and forward the converted information to an XML interface of the marketplace; receive, by the associated processing financial institution, payment of funds from the buyer; and forward the received funds to a predetermined payee.

According to another aspect of the present invention, there is provided a method of a central processing platform facilitating an exchange of information and funds between a seller participant in an e-commerce marketplace and a buyer participant in the e-commerce marketplace. The central processing platform controls an associated processing financial institution. The method comprises: receiving billing information and other transaction information from the seller; converting the billing information to an extensible markup language (XML) and forwarding the converted information to an XML interface of the marketplace; receiving, by the associated processing financial institution, payment of funds from the buyer; and forwarding the received funds to a predetermined payee.

According to another aspect of the present invention, there is provided an apparatus for facilitating commerce between a buyer and a seller. The apparatus includes a central processing platform comprising: means for translating seller information relating to a product or service sale from a seller information format into a buyer information format and forwarding the translated information to the buyer; means for validating a transaction by matching billing information associated with the product sale, and supplied electronically by the seller to the central processing platform, with receipt and acceptance information associated with the product, supplied electronically by the buyer to the central processing platform; and means for discriminating and reconciling discrepancies between the billing information and the receipt and acceptance information.

According to another aspect of the present invention, there is provided a method for a central processing platform facilitating commerce between a buyer and a seller. The method comprises: translating seller information relating to a product or service sale from a seller information format into a buyer information format and forwarding the translated information to the buyer; validating a transaction by matching billing information associated with the product sale, and supplied electronically by the seller to the central processing platform, with receipt and acceptance information associated with the product, supplied electronically by the buyer to the central processing platform; and discriminating and reconciling discrepancies between the billing information and the receipt and acceptance information.

### BRIEF DESCRIPTION OF THE DRAWINGS

FIG. 1 is a diagram illustrating the material and informational flow involved in a conventional commercial transaction between a buyer and a seller;

FIG. 2 is a diagram illustrating the material and informational flow involved in a commercial transaction between a buyer and a seller using the central processing platform of the present invention;

FIG. 2A is a diagram illustrating the informational flow and processing related to the translation engine of the present invention;

FIG. 2B is a process diagram illustrating the informational flow and processing related to the validation engine of the present invention;

FIG. 2C is a process diagram illustrating the informational flow and processing related to the reconciliation engine of the present invention;

FIG. 3 is a process diagram illustrating the informational flow involved in a commercial transaction in which a factor is involved utilizing the central processing platform of the present invention;

FIG. 4 is a diagram illustrating the informational flow involved in a commercial transaction in which a bank is involved utilizing the central processing platform of the present invention;

FIG. 5 is a diagram illustrating the material and informational flow involved in a commercial transaction between a buyer, a seller, financing entities and sources of information using the central processing platform of the present invention;

FIG. 6 is a block diagram showing how the central processing platform of the present invention interacts with a commercial e-commerce exchange; and

FIG. 7 is a diagram illustrating the flow of materials, funds and information in a process for converting a receivable into a tradeable instrument.

### DETAILED DESCRIPTION OF THE PREFERRED EMBODIMENTS

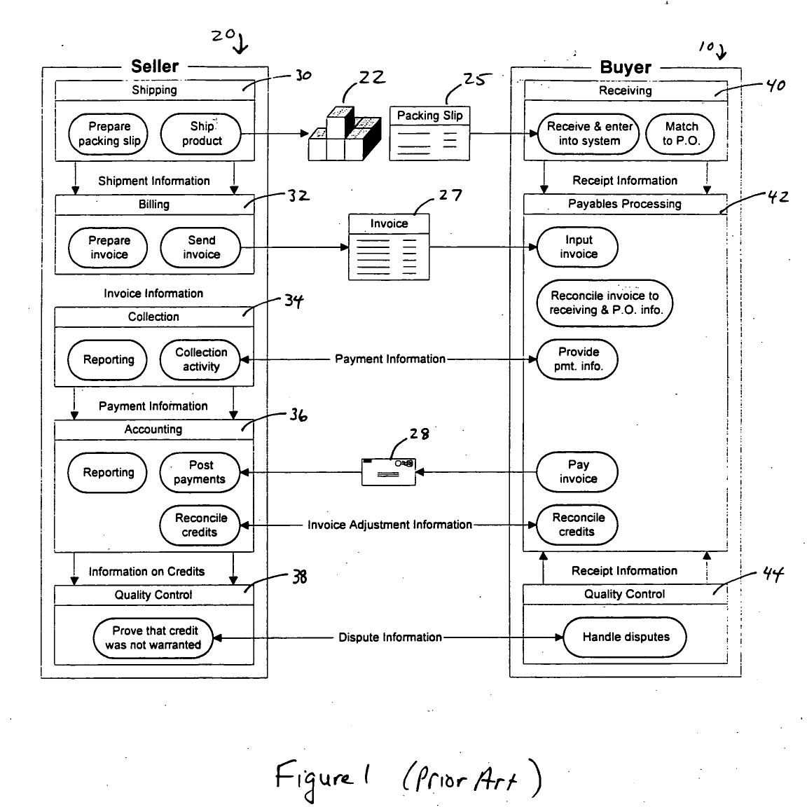

As was discussed above with respect to prior art FIG. 1, in conventional transactions, a great deal of manual effort is required to keep track of and reconcile each line item and to determine which line items are to be paid. The present invention alleviates much of the manual effort by providing individual businesses access to a centralized processing platform and database, as well as translation, validation and reconciliation processing structures, to be referred to as “engines”, that eliminate many of the steps necessary in prior art receivables processing.

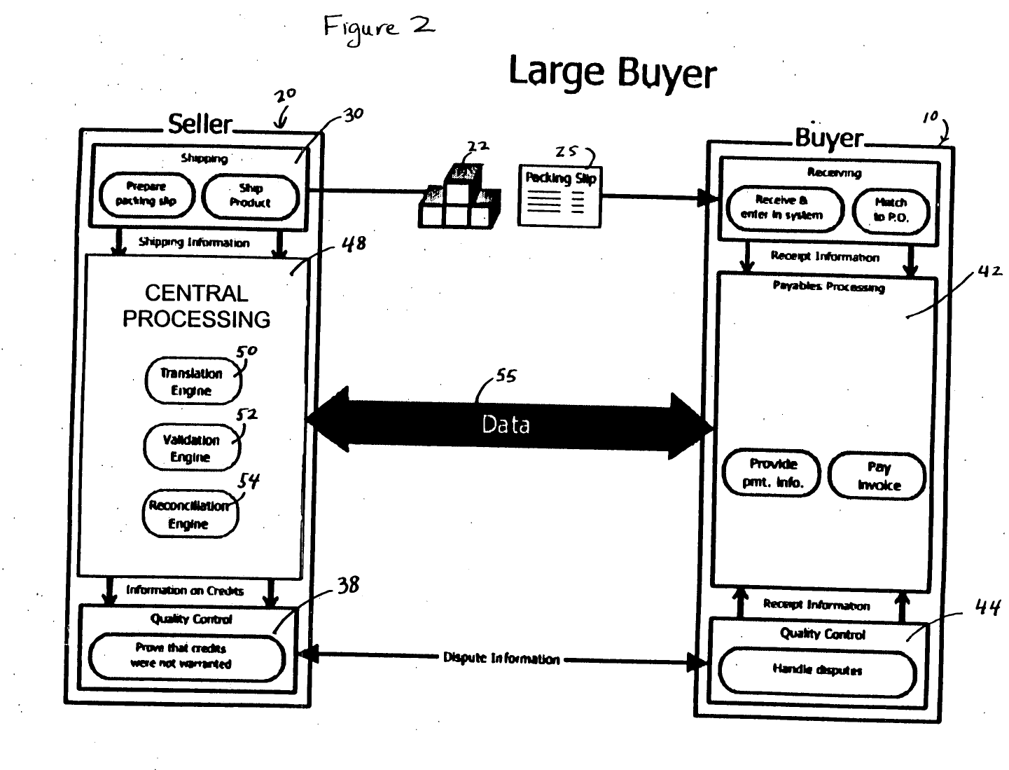

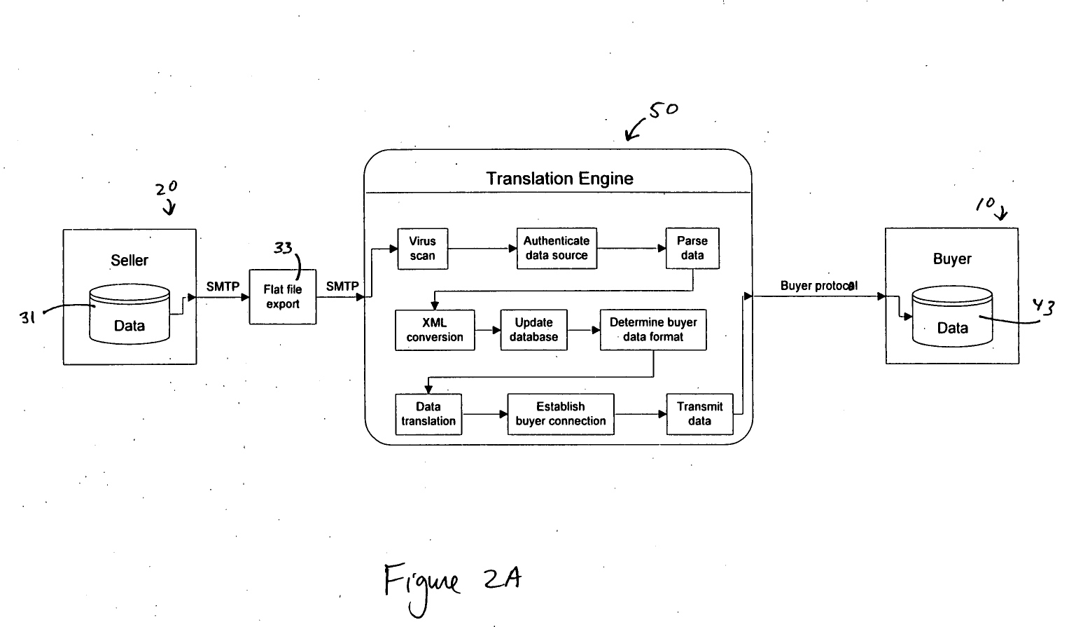

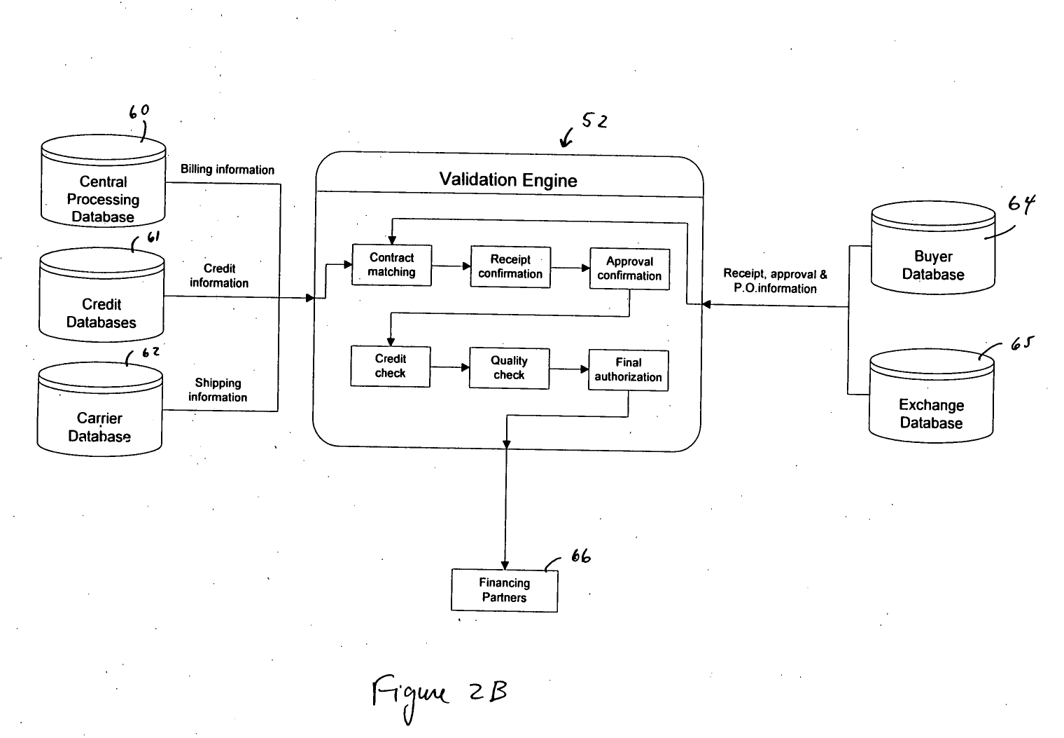

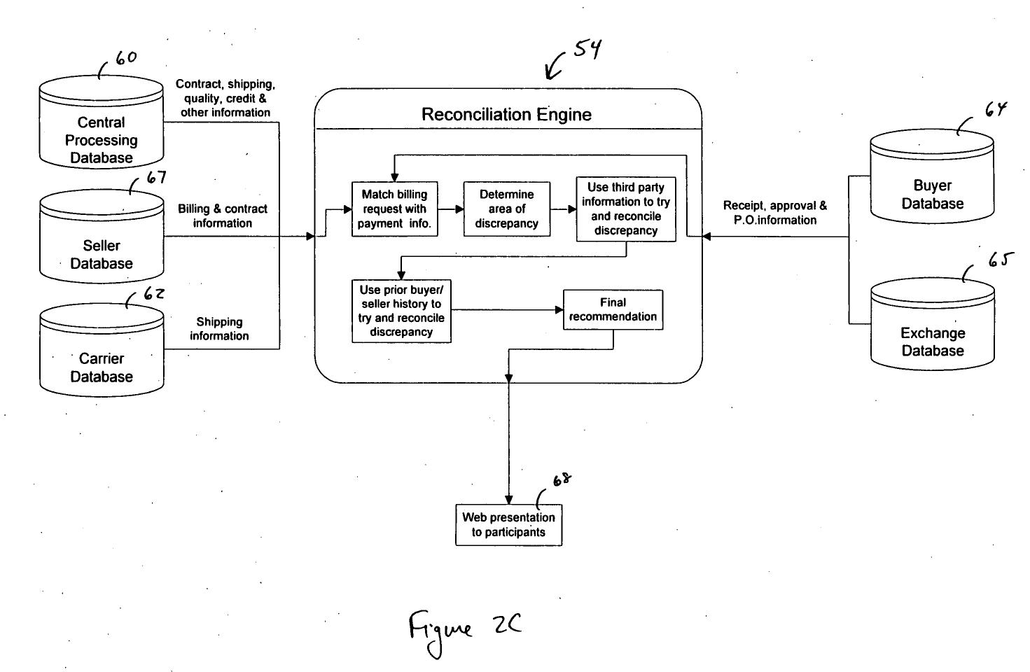

FIG. 2 illustrates how the centralized processing platform of the present invention can be used to greatly simplify the type of transaction that was illustrated in prior art FIG. 1. As shown in FIG. 2, after the purchased items have been forwarded to the buyer, the seller's shipping department 30 sends shipping information to the central processing platform 48. The interface between the central processing platform 48 and other parties can be effected by means of the World Wide Web, dedicated EDI, e-mail, or any other appropriately rapid means of electronic communication. In a preferred embodiment, the seller visits a Web site run by a central processing platform Web server application and either fills out a data entry form, uploads a flat file export from their bar-code, advance ship notice or accounting systems, or registers for open database connectivity (ODBI) to allow the central processing platform 48 to directly access its database during the transaction. A flat file is a non-indexed data file. These files are exported from various software packages and e-mailed to the central processing platform 48.

The central processing platform 48, which is in

communication with the parties to the transaction, uses the translation engine 50, the validation engine 52 and the reconciliation engine 54, each to be described in more detail below, to settle all line items and assist in resolving disputes. Any requests from the buyer 10 for credits are received by the central processing platform 48 directly from the buyer 10 and it is the central processing platform 48, not the seller 20, that performs the function of determining which credits. are to be applied to which line item.

More specifically, in the illustrated transaction, the translation engine 50 ensures that billing information sent to the buyer 10 is in a format acceptable to the buyer 10. This is done by comparing the translation utilized by the seller 20 with that used by the buyer 10 and performing a translation if necessary. At the same time, the central processing platform 48 inserts the billing information into the database of the central processing platform 48. The validation engine 52 then validates line item shipping information with the buyer to ensure payment by the buyer. More particularly, in a preferred embodiment, the validation engine 52 electronically queries the receipts system of the buyer 10 to check for product receipt and acceptance. Shipment information is matched against purchase and release orders to determine the amount due and the payment date. Expected payment dates and amounts are set based upon the database information.

The reconciliation engine 54 electronically reconciles shipping line item exceptions. Specifically, rather than have human operators call the buyer, as in the prior art, the reconciliation engine 54 applies heuristic analysis to determine the likely cause of the discrepancy. An example of an occurrence that can be used in such analysis would be where a buyer 10 does not show a receipt, but a third party carrier confirms delivery. Another is where seller 20 sent and billed for items in excess of what was released by the buyer 10. The seller 20 is then presented with the information. In a preferred embodiment of the present invention, the seller 20 may be presented with the results of the reconciliation engine 54 via an HTML interface, such as a Web browser.

The process flows for the translation, validation and reconciliation engines are described next with respect to the process charts of FIGS. 2A, 2B, and 2C.

FIG. 2A illustrates how the translation engine 50 interacts with the buyer and seller, as well as the steps performed by the translation engine. The translation engine 50 translates information provided by the seller 20 in a seller-format into information conforming to a buyer 10 protocol. The seller 20 preferably e-mails information from its database 31, using simple mail transfer protocol (SMTP) by means of a flat file export 33. The translation engine 50 receives the incoming e-mail information and performs several operations on the data to translate it into buyer protocol. First, the incoming information is subjected to a virus scan, followed by an authentication of the source of the information. The data then is parsed and an XML conversion done. The information is stored in XML format for display on the Web site of the central processing platform for display there or on e-commerce exchanges. The translation engine 50 then updates the central processing platform's database and makes a determination of the buyer's format. Appropriate data translation is performed in accordance with the determination. Next, a connection is established with the buyer and the translated data is transmitted to the buyer 10, where the incoming information is stored in buyer's database 43.

The validation engine 52 uses information input from a number of sources to validate line item shipping information with the buyer to ensure payment by the buyer. More particularly,. in a preferred embodiment, the validation engine 52 electronically queries the receipts system of the buyer 10 to check for product receipt and acceptance. Shipment information is matched against purchase and release orders to determine the amount due and the payment date. Expected payment dates and amounts are set based upon the database information. From the central processing database 60, billing information is input to the validation engine 52. Credit information is input from the credit databases 61, which are maintained by various credit insurance companies, information providers, such as Dun & Bradstreet, banks, and the central processing platform itself. In addition, the validation engine receives shipping information, preferably from carrier database 62. Receipt, approval and purchase order information also is input to the validation engine 52. All of the input information is subjected to a contract matching function. Next, receipt confirmation is performed, followed by approval confirmation. A credit check and a quality check are performed, after which a final authorization processing step is performed. The validation is then output to financing partners 66. While in the figure, the output of the validation is shown only being directed to the financing partners 66, others may receive the information. For example, the output from the validation engine may be used by a buyer whose system is incapable of doing appropriate payment validation internally. An example would be a company that uses an Oracle financial system, an Ariba procurement system and a variety of different receipt systems worldwide. These systems do not communicate with one another, making it impossible for the Oracle application to perform necessary validation of payments. The result is many erroneous payments. The use of the validation engine of the present invention would solve this problem. In particular, the validation engine would get information feeds from the various systems, validate payment, then feed the appropriate payment information back to the Oracle financial system for payment.

FIG. 2C illustrates the informational and processing flow involved in operation of the reconciliation engine. The reconciliation engine 54 electronically reconciles shipping line item exceptions. To assist in this process, the reconciliation engine 54 receives information from several sources. Contract, shipping, quality, credit and other information is input from the central processing database 60. Billing and contract information is input from the seller database 67. Shipping information is input from the carrier database 62. Receipt, approval and purchase order information is input from the buyer database 64, and, if an e-commerce exchange is involved, that information also is input from an exchange database 65. The reconciliation engine 54 utilizes the input information to match billing request with payment information, determine any areas of discrepancy between them, and use third party information to try to reconcile the discrepancy. Prior buyer/seller history is also used to try to reconcile the discrepancy. Once these process steps have been completed, the reconciliation engine 54 makes a determination as to a final recommendation. The final recommendation is preferably made available at a Web site of the central processing platform via a Web presentation 68.

After execution of the translation, validation and reconciliation engines, central processing platform 48 passes on to seller's quality control department 38 the information as to any credits which may be claimed by the buyer. At that point, exchanges of dispute information, if any, are made directly with buyer's quality control department 44. As can be appreciated from the above, the central processing platform 48 of the present invention relieves the seller of a significant portion of the effort usually expended in conventional transactions.

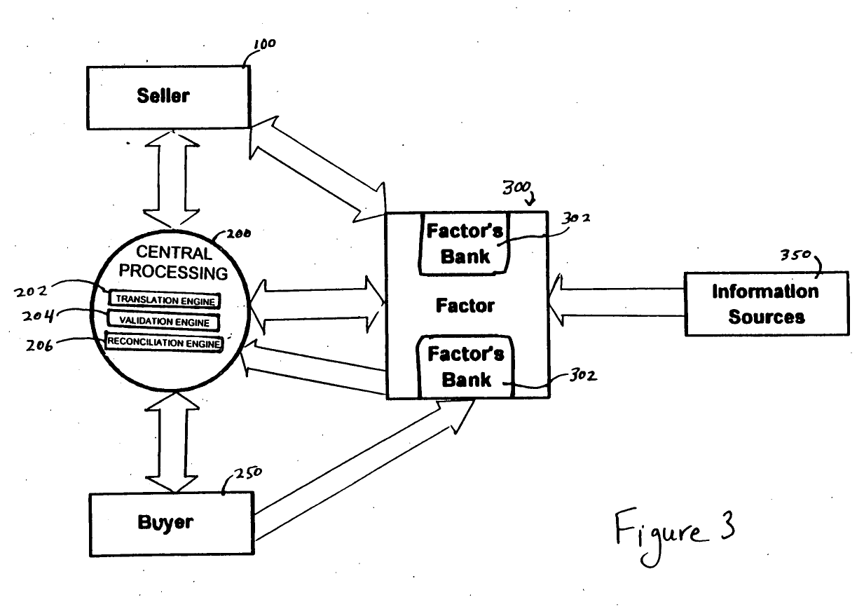

Transactions such as the one described with reference to FIG. 2 often involve third parties such as factors, which enter into the transaction by purchasing one or more invoices from the seller. To minimize the risk such purchase entails, factors require a great deal of information regarding the current transaction, as well as the prior history of both the buyer and the seller. Since the central processing platform of the present invention monitors the transactional activities of buyers and sellers utilizing its services, the central processing platform of the present invention is in an excellent position to serve as a source of this information to factors, greatly reducing the expenditure of effort required in deciding whether or not to purchase an invoice from a seller. FIG. 3 illustrates an exemplary scenario in which the translation, validation, and reconciliation engines of the present invention are utilized to facilitate a transaction between a factor, a buyer and a seller.

As is shown in the figure, the parties to the exemplary transaction are a seller 100, the central processing platform 200 of the present invention, the buyer 250, the factor 300 itself, and outside sources of information 350. Communication between the parties is represented by the arrows connecting the parties in the figure. Such communication can be by EDI, the Internet, or by any conventional electronic communication method. In a preferred embodiment, the seller visits a Web site at the central processing platform and either fills out a data entry form, uploads a flat file export from either its bar-code, advance ship notice or accounting systems, or registers for ODBI to allow the central processing platform to directly access its database.

After delivery of goods or services (not shown) from the seller 100 to the buyer 250, billing information is sent by the seller 100 to central processing platform 200. Central processing platform 200 uses the translation engine 202 to translate the seller's billing information into a format understandable by the buyer 250, and at the same time the central processing platform 200 inserts the billing information into its database.

Next, the translated billing information is sent to the buyer 250. Then, central processing platform 200 requests information from the buyer 250 and the buyer 250 responds with the requested information. The information will typically be of a type helpful in assessing the likelihood that the buyer 250 will pay the bill. This information, combined with any past history of the buyer 250 known to the central processing platform 200, will then be analyzed by the validation engine 204 in central processing platform 200. If the validation engine 204 is satisfied, a billing authorization is sent to the factor 300 as well as to the seller 100. The factor 300 also at that time receives financial information from the outside information sources 350 to aid in assessing the credit risk of the buyer 250. The seller 100 then sends a purchase request to the factor 300, offering an invoice for sale. The factor 300, armed with the information from the outside information sources 350 and the billing authorization, instructs their bank 302 to sends an advance payment, typically 80% of the invoice, to the seller 100. The central processing platform 200 issues a payment request to the buyer 200, asking that the buyer 200 pay the factor's bank 302, instead of the seller 100. The buyer 250 then pays the invoice directly to the factor's bank 302.

To assure proper bookkeeping, and to add to the central processing platform experiential database, the factor's bank 302 then sends payment information to the central processing platform 200. This information is analyzed by the reconciliation engine 206. Once all the accounts have been reconciled, payment information is forwarded from the central processing platform 200 to the seller 100 and to the factor 300. The factor 300 then forwards the seller 100 a refund of the difference between the invoice payment and the advance, less the factor's commission, completing the transaction.

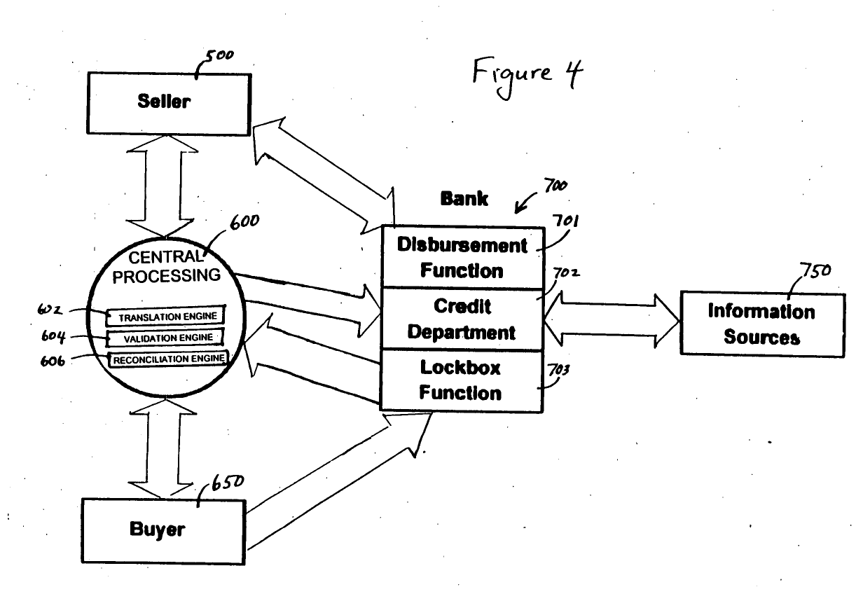

Rather than sell their invoices outright, sellers also have the option to obtain financing from a bank, the financing being based upon receivables. This financing generally takes the form of a line of credit. FIG. 4 illustrates a typical transaction using the central processing platform of the present invention in which a seller borrows money from a bank in anticipation of receiving payment from a buyer. As will be developed, this process proceeds similarly to the factor example discussed above with reference to FIG. 3. In the illustrated exemplary transaction, the participants are the central processing platform 600 of the present invention, the seller 500, the buyer 650, outside information sources 750, and the bank 700. The bank 700 is illustrated as being divided into a disbursement function 701, which actually disburses funds, a credit department 702, and a lockbox function 703, which receives funds.

Once purchased items (not shown) have been sent from the seller 500 to the buyer 650, billing information is sent by the seller directly to the central processing platform 600. The translation engine 602 is. applied to translate the billing information into a format the buyer 650 can use. The translated billing information is then forwarded to the buyer 650. Next, the central processing platform 600 initiates a communication with the buyer 650 requesting receipt and approval information. After receiving the information from the buyer 650, the central processing platform applies the validation engine 604 to the received information. If the validation engine 604 is satisfied, central processing platform 600 issues borrowing certificates to the credit department 702 of the bank 700 and to the seller 500. At the same time, the credit department 702 receives information from information sources 750. The seller 500 then forwards a loan request to the bank 700, and, if all goes well, the bank forwards the loan to the seller 500. Next, the central processing platform 600 sends a payment request to the buyer 650.

In response to the request, the buyer 650 sends the payment to the lockbox function 703 of the bank 700. The lockbox function 703 sends payment information to the central processing platform 600, which then uses the reconciliation engine 606 to reconcile the account of the buyer, seller and bank. The central processing platform 600 then sends payment information to each of the seller 500 and the credit department 702 of the bank 700, completing the transaction.

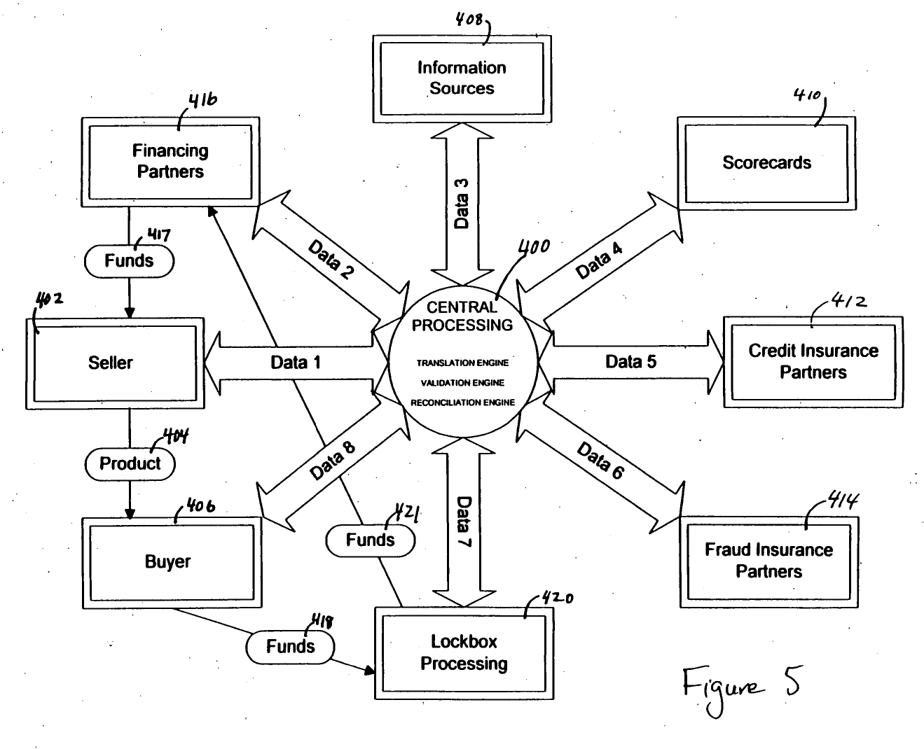

To illustrate the central processing platform's role as a facilitator of commercial transactions, the functions of the translation, validation and reconciliation engines of the present invention will now be described in the context of a typical payment application with reference to FIG. 5. The parties to the illustrated payment application include the central processing platform, the seller, buyer, lock box processing, fraud insurance partners, credit insurance partners, score cards, information sources, and financing partners.

As a first step in the process, the seller 402 provides a product 404, which may consist of goods or services, to the buyer 406. Billing information is then forwarded to the central processing platform 400 over data channel 1. The translation engine running at central processing platform 400 translates the billing information into a format that can be read by the buyer 406, inserts the information into the central processing platform database, and forwards the translated billing information to the buyer 406 over data channel 8.

The central processing platform 400 then conducts a series of communications for the purpose of accessing credit risk and pricing credit insurance. Towards this end, the central processing platform 400 submits a request for information to outside information sources 408 over data channel 3, and receives the information in response over the same channel. The central processing platform 400 then sends a score request to a scorecard 410 over data channel 4 to determine the insolvency risk of the buyer. The scorecard 410 sends the score to the central processing platform 400 over the same channel. Then, central processing platform 400 sends an insurance request to credit insurance partners 412 over data channel 5, which, if all goes well, those insurance partners provide a validation of such insurance using the same data channel.

The central processing platform 400 then requests information from the buyer 406 over data channel 8. After receipt of the information by the central processing platform 400, the information, and the other previously-received information, is analyzed by the validation engine. The central processing platform also matches shipment information received from the seller against purchase and release orders to determine the amount due and the payment date. Expected payment dates and amounts are set based upon information stored in the database of the central processing platform 400. Next, a fraud insurance request is sent over data channel 6 to fraud insurance partners 414. If all goes well, those insurance partners provide a confirmation of the fraud insurance over the same data channel.

Next, the central processing platform 400 sends funding information to the financing partners 416 over data channel 2 and requests the financing partner 416 to fund the seller 402. In response, the financing partners advance funds 417 to the sellers 402, by any conventional means. The central processing platform 400 then sends a payment request to the buyer 406 over data channel 8, which in turn makes a payment of funds 418 to the lockbox processing 420. Once the payment has been received, the lockbox 420 sends payment information, e.g., lockbox remittances, to the central processing platform 400 over data channel 7. The reconciliation engine uses this information to reconcile the accounts of the parties. The central processing platform 400 sends wiring information to the lockbox 420 over data channel 7, to authorize the lockbox 420 to forward funds 421 to the financing partners that provided the funds 417 originally to the seller. The central processing platform 400 then forwards payment information to both. the seller and the financing partner, over data channels 1 and 2, respectively.

The automated verification and collection over the Internet or traditional electronic data interchange (EDI) made possible with the central processing platform of the present invention will allow businesses to achieve significant cost savings. With time, the electronic communication effected between the central processing platform and the parties described above will result in a nearly unlimited number of electronic informational pipelines, which will allow the verification and collection processes to become fully automated.

The present invention will have other benefits as well. For example, currently, factors must line up fraud and credit insurance on a case by case basis. However, by utilizing the central processing platform of the present invention, which will develop, through use, a relationship with providers of such insurance, factors that previously could not afford to purchase such services will be able to take advantage of the economies of scale offered by the central processing platform.

As discussed above, some very large buyers have set up their own B2B exchanges to help meet their procurement needs. These exchanges allow the buyer to compare quotes from many would-be suppliers and select, for example, the one with the lowest bid, or to use other selection criteria. Such buyers often have specific EDI standards they require for all electronic financial communication. However, many small suppliers, who otherwise would be capable of providing products and/or services for the large buyer, cannot afford to set up the computing infrastructure required to communicate using the buyer's EDI. The present invention provides a solution to this problem by providing an XML bridge that allows smaller players to participate in such exchanges.

Also, at present, no efficient payment method exists for these exchanges. The present invention provides such a payment method.

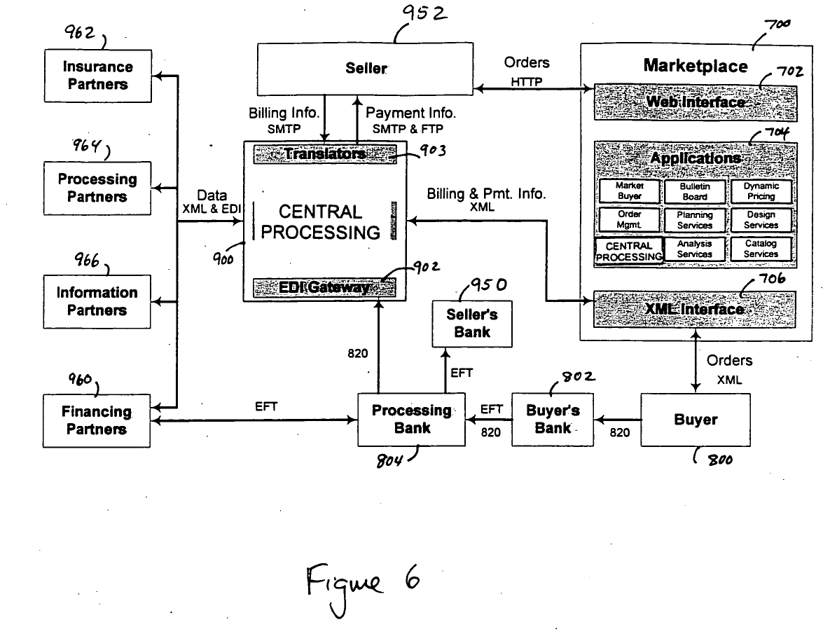

FIG. 6 is a block diagram illustrating how the processing platform of the present invention works together with a B2B marketplace to allow smaller suppliers to participate and to provide the marketplace with a payment method. The components involved in the illustrated example include the marketplace 700, the buyer 800, buyer's bank 802, processing bank 804, central processing platform 900, seller's bank 950, seller 952, financing partners 960, insurance partners 962, processing partners 964 and information partners 966. The marketplace 700 includes a Web interface 702, applications 704, and XML interface 706. The applications 704 include applications to provide a market buyer, a bulletin board, dynamic pricing, order management, planning services, design services, the central processing platform of the present invention, analysis services and catalog services, and may include other applications not shown, such as applications for running auctions and reverse auctions.

In a typical transaction, the seller 952 exports and e-mails to the central processing platform 900 a file containing its billing information, generated, for example, from a bar code application resident at the seller 952. Central processing platform 900 parses the received file, converts it to XML and forwards the converted file to the marketplace 700 through the marketplace's XML interface 706. The buyer 800, who generally pays via EDI, initiates payment. The buyer 800 may receive bills via EDI, XML, or not at all. Many companies pay off of the receipt information (known as available receipts) and do not receive invoices. The buyer 800 transmits remittance advice information, known as “820's”, to the buyer's bank 802, which relays funds, preferably by electronic funds transfer (EFT), and 820's to the processing bank 804, which in the present invention will be controlled by the central processing platform 900. Alternately, the payment may be made to the bank of the factor or lending bank. The processing bank 804 forwards the 820 information to the central processing platform 900, which converts the EDI messages to XML and updates the marketplace with regard to payment information through the marketplace's XML interface 706. The funds are then sent, preferably by EFT, to the seller's bank 950, or alternately, to the factor or lending bank, represented by the financing partners 960. Note that the ERP system of some buyers will be capable of issuing purchase orders directly with the XML interface of a marketplace. Others will continue to issue orders through traditional mechanisms, including EDI and mail. Sellers will typically use a Web browser to view orders on the marketplace. The central processing platform 900 will convert some EDI and paper orders to XML and put them back on the marketplace for viewing by participants.

As will be appreciated, advance payment on billings may be made in cooperation with the financing partners 960, insurance partners 962, processing partners 964 and information partners 966. The prior operation of the central processing platform's validation engine, which matches billing information from the seller 952 with receipt and approval information from the buyer 800 and marketplace 700 through the XML interface as well as through EDI, makes it safe for the various partners to advance cash based on the billing obligation. This cash flows to the processing bank 804, which then completes the payment cycle in advance of getting cash from the buyer's bank 802.

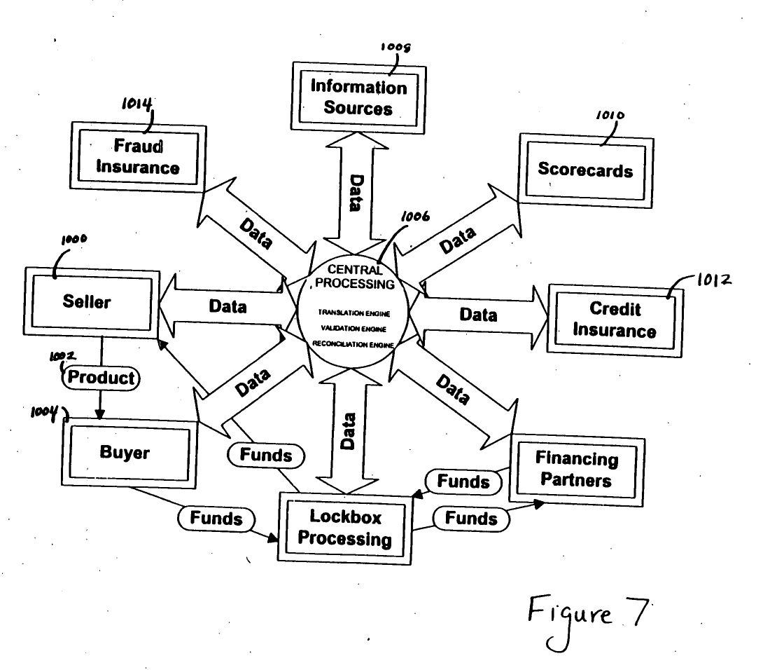

FIG. 7 illustrates a process flow in which operation of the central processing platform of the present invention allows a billing invoice to be converted into a tradeable financial instrument. After shipping product 1002, the seller 1000 transmits billing information to the central processing platform 1006. The central processing platform 1006 translates billing information into the buyer's format using the translation engine. The central processing platform 1006 then transmits billing information to the buyer 1004. The central processing platform 1006 then accesses information sources 1008 and scorecards 1010 to assess buyer 1004 credit risk. The central processing platform 1006 prices and obtains credit insurance on the buyer 1004 from credit insurance provider 1012. The central processing platform's validation engine then assesses the likelihood of payment of the bill through various rules applied to information received from the seller 1000, the buyer 1004 and third party sources of information. The central processing platform 1006 prices and obtains fraud insurance on the process from fraud insurance providers 1014. The central processing platform 1006 then prices and obtains product risk insurance. The central processing platform 1006 becomes payment agent for a billing that is now insured against non-payment, and ready for sale as a tradable financial instrument. Cash received from the buyer of the instrument, such as a factor or a bank, is forwarded to the seller 1000. The instrument buyer is repaid when the buyer 1004 ultimately pays the obligation. Any discrepancies between amounts paid and billed are handled by the reconciliation engine of the central processing platform 1006. Preferably, such obligations are the obligation of the seller 1000.

As has been described above, the central processing platform of the present solves many of the problems involved in B2B commerce by centralizing many of the processing and communication steps performed in transacting such commerce. The illustrated examples discussed above have been described in terms of the preferred embodiments. It is to be understood, however, that the invention is not limited to those embodiments, examples, and systems, and that various changes and modifications may be made by those of ordinary skill in the art without departing from the spirit and the scope of the appended claims.

What is claimed is:

1. A system for facilitating commerce between a buyer and a seller, said system including a central processing platform comprising:
a translation engine adapted to translate seller information relating to a product or service sale from a seller information format into a buyer information format and to forward the translated information to the buyer;
a validation engine adapted to validate a transaction by matching billing information associated with the product sale, and supplied electronically by the seller to the central processing platform, with receipt and acceptance information associated with the product, supplied electronically by the buyer to the central processing platform; and
a reconciliation engine adapted to discriminate and reconcile discrepancies between the billing information and the receipt and acceptance information.

2. A system according to claim 1, wherein the seller information is sent to the central processing platform by e-mail.

3. A system according to claim 1, wherein the seller information is sent to the central processing platform by the seller filling out an HTML form at a Web site of the central processing platform.

4. A system according to claim 1, wherein the seller information is directly accessed by the central processing platform from a database of the seller.

5. A server on a network, said server facilitating commerce between a buyer and a seller and being operable to:
receive information from the seller in a seller information format, the information relating to a commercial transaction between the seller and the buyer;
translate the received information into a buyer information format and forward the translated information to the buyer;
validate a transaction by matching billing information associated with the commercial transaction, and supplied electronically by the seller to the server, with receipt and acceptance information associated with the commercial transaction, supplied electronically by the buyer to the server; and
discriminate and reconcile discrepancies between the billing information and the receipt and acceptance information.

6. A server according to claim 5, wherein the seller information is sent to the server by e-mail.

7. A server according to claim 5, wherein the seller information is sent to the server by the seller filling out an HTML form at a Web site of the server.

8. A server according to claim 5, wherein the seller information is directly accessed by the server from a database of the seller.

9. Computer code for transaction validation and reconciliation, said computer code comprising:
code for receiving billing information from a seller involved in a commercial transaction;
code for obtaining receipt and acceptance information from a buyer in the commercial transaction; and
code for discriminating discrepancies between the billing information and the receipt and acceptance information.

10. Computer code according to claim 9, wherein the seller information is received via e-mail.

11. Computer code according to claim 9, wherein the seller information is received in response to the seller filling out an HTML form at a Web site controlled by a processor running the computer code.

12. Computer code according to claim 9, wherein the seller information is directly accessed from a database of the seller by a processor running the computer code.

13. Computer code according to claim 9, further comprising code for reconciling discrepancies between the billing information and the receipt and acceptance information.

14. A method for a central processing platform to convert a receivable, to be-paid by a buyer to a seller, into a tradeable financial instrument, comprising:
obtaining credit information relating to the buyer;
procuring insurance against non-payment of the receivable by the buyer;
assessing risk of non-payment by the buyer based upon the obtained credit information, and information relating to the seller, in accordance with predetermined rules;
procuring fraud insurance as to the receivable;
procuring insurance against non-acceptance by the buyer of a product associated with the receivable; and
becoming a payment agent for the receivable.

15. A central processing platform controlling an associated processing financial institution, the central processing platform for facilitating an exchange of information and funds between a seller participant in an e-commerce marketplace and a buyer participant in the e-commerce marketplace, the central processing platform being operable to:
receive billing information and other transaction information from the seller;
convert the billing information to an extensible markup language (XML) and forward the converted information to an XML interface of the marketplace;
receive, by the associated processing financial institution, payment of funds from the buyer; and
forward the received funds to a predetermined payee.

16. A central processing platform according to claim 15, wherein the predetermined payee is the seller or a representative of the seller.

17. A central processing platform according to claim 15, wherein the predetermined payee is a financial institution that previously has provided financing to the seller.

18. A method of a central processing platform facilitating an exchange of information and funds between a seller participant in an e-commerce marketplace and a buyer participant in the e-commerce marketplace, the central processing platform controlling an associated processing financial institution, the method comprising:
receiving billing information and other transaction information from the seller;
converting the billing information to an extensible markup language (XML) and forwarding the converted information to an XML interface of the marketplace;
receiving, by the associated processing financial institution, payment of funds from the buyer; and
forwarding the received funds to a predetermined payee.

19. An apparatus for facilitating commerce between a buyer and a seller, said apparatus including a central processing platform comprising:
means for translating seller information relating to a product or service sale from a seller information format into a buyer information format and forwarding the translated information to the buyer;
means for validating a transaction by matching billing information associated with the product sale, and supplied electronically by the seller to the central processing platform, with receipt and acceptance information associated with the product, supplied electronically by the buyer to the central processing platform; and
means for discriminating and reconciling discrepancies between the billing information and the receipt and acceptance information.

20. A method for a central processing platform facilitating commerce between a buyer and a seller, said method comprising:
translating seller information relating to a product or service sale from a seller information format into a buyer information format and forwarding the translated information to the buyer;
validating a transaction by matching billing information associated with the product sale, and supplied electronically by the seller to the central processing platform, with receipt and acceptance information associated with the product, supplied electronically by the buyer to the central processing platform; and
discriminating and reconciling discrepancies between the billing information and the receipt and acceptance information.
